(19) United States
(12) Patent Application Publication
(10) Pub. No.: US 2008/0262889 A1
(43) Pub. Date: Oct. 23, 2008

(54) BUSINESS TRANSFORMATION MANAGEMENT

(76) Inventors: Rong Zeng Cao, (US); Wei Ding, (US); Juhnyoung Lee, Yorktown Heights, NY (US); Shih-Gong Thomas Li, San Jose, CA (US); Chun Hua Tian, (US)

Correspondence Address: HOFFMAN WARNICK LLC, 75 State Street, 14th Floor, ALBANY, NY, 12207, US

(21) Appl. No.: 12/163,281

(22) Filed: Jun. 27, 2008

Related U.S. Application Data
(63) Continuation of application No. 11/427,137, filed on Jun. 28, 2006.

(51) Int. Cl. G06Q 10/00

(52) U.S. Cl. 705/7

(57) ABSTRACT

A solution for managing a business transformation is provided. The invention obtains an impact of a business solution for the business transformation on a business concern for an enterprise and relationship information for the business concern with one or more other business concerns and/or value (business) metrics. The impact of the business solution is propagated to a set of business concerns and/or value metrics based on the relationship information. The impact can include a time delay factor, which can be used during evaluation to perform numerous financial related metrics (e.g., return on investment). The relationship information and/or impact can be derived from empirical data using regression analysis or the like. In order to facilitate evaluation of the business transformation, various improved graphical interfaces can be generated that highlight the changes caused by the business transformation for use by a user.

### REFERENCE TO RELATED APPLICATIONS

The current application is a continuation of co-pending U.S. patent application Ser. No. 11/427,137, titled “Business Transformation Management”, which was filed on 28 Jun. 2006, and which is hereby incorporated by reference. The current application is related to co-owned and co-pending U.S. patent application Ser. No. 11/200,847, filed on Aug. 10, 2005, and entitled “Business Solution Evaluation” and co-owned and co-pending U.S. patent application Ser. No. 11/200,727, filed on Aug. 10, 2005, and entitled “Value Model”, both of which are hereby incorporated herein by reference.

### FIELD OF THE INVENTION

The invention relates generally to business transformation management, and more particularly, to a solution for evaluating and/or monitoring a business solution for the business transformation.

### BACKGROUND OF THE INVENTION

Research on Return on Investment (ROI) analysis and impact analysis of business solutions in terms of their quantitative business value is ongoing. An area in which these analyses are important is project portfolio management. Project portfolio management selects and prioritizes candidate investments for business transformation (e.g., business initiatives, projects, and/or the like) based on their potential to improve business performance and/or value. When selecting the candidate investments, project portfolio management also considers additional factors, such as remaining within one or more business constraints, e.g., budget, resources, and the like.

ROI analysis techniques provide a calculation that is used to determine whether a specific proposed investment is wise, and how well it will repay the investor. However, current ROI analysis techniques are limited in that the calculation is typically only based on simple financial measures, such as cost reduction. Further, in general, ROI analysis is difficult to generalize. Consequently, current ROI analysis techniques are frequently project-based tools and/or focus on specific business activities. However, a business often requires a wide range of solutions to empower every aspect of business operations. As a result, it is costly for the business to simultaneously evaluate multiple solutions, obtain a complete picture of the impact of these solutions, and determine which solutions are best.

In view of the foregoing, a need exists to overcome one or more of the deficiencies in the related art.

### BRIEF SUMMARY OF THE INVENTION

The invention provides a solution for managing a business transformation. The invention obtains an impact of a business solution for the business transformation on a business concern for an enterprise and relationship information for the business concern with one or more other business concerns and/or value (business) metrics. The impact of the business solution is propagated to a set of business concerns and/or value metrics based on the relationship information. The impact can include a time delay factor, which can be used during evaluation to perform numerous financial related metrics (e.g., return on investment). The relationship information and/or impact can be derived from empirical data using regression analysis or the like. In order to facilitate evaluation of the business transformation, various improved graphical interfaces can be generated that highlight the changes caused by the business transformation for use by a user.

A first aspect of the invention provides a method of managing a business transformation, the method comprising: obtaining an impact of a business solution for the business transformation on a business concern, the impact including a time delay factor; obtaining relationship information for the business concern and at least one of: a set of value metrics or a set of other business concerns; propagating the impact to at least one of: another business concern or a value metric based on the relationship information; and evaluating the business transformation based on the propagated impact.

A second aspect of the invention provides a system for managing a business transformation, the system comprising: a system for obtaining an impact of a business solution for the business transformation on a business concern, the impact including a time delay factor; a system for obtaining relationship information for the business concern and at least one of: a set of value metrics or a set of other business concerns; a system for propagating the impact to at least one of: another business concern or a value metric based on the relationship information; and a system for evaluating the business transformation based on the propagated impact.

A third aspect of the invention provides a computer program comprising program code stored on a computer-readable medium, which when executed, enables a computer system to implement a process of managing a business transformation, the process comprising: obtaining an impact of a business solution for the business transformation on a business concern, the impact including a time delay factor; obtaining relationship information for the business concern and at least one of: a set of value metrics or a set of other business concerns; propagating the impact to at least one of: another business concern or a value metric based on the relationship information; and evaluating the business transformation based on the propagated impact.

A fourth aspect of the invention provides a method of generating a system for managing a business transformation, the method comprising: providing a computer system operable to: obtain an impact of a business solution for the business transformation on a business concern, the impact including a time delay factor; obtain relationship information for the business concern and at least one of: a set of value metrics or a set of other business concerns; propagate the impact to at least one of: another business concern or a value metric based on the relationship information; and evaluate the business transformation based on the propagated impact.

A fifth aspect of the invention provides a business method for managing a business transformation, the business method comprising managing a computer system that performs the process described herein; and receiving payment based on the managing.

The illustrative aspects of the present invention are designed to solve one or more of the problems herein described and/or one or more other problems not discussed.

### BRIEF DESCRIPTION OF THE SEVERAL VIEWS OF THE DRAWINGS

These and other features of the invention will be more readily understood from the following detailed description of the various aspects of the invention taken in conjunction with the accompanying drawings that depict various embodiments of the invention, in which:

FIG. 1 shows an illustrative environment for managing a business transformation according to an embodiment of the invention.

FIG. 2 shows an illustrative user interface that can be generated by definition module according to an embodiment of the invention.

FIG. 3 shows an illustrative value model according to an embodiment of the invention.

FIG. 4 shows an illustrative display for displaying an evaluation of the business transformation according to an embodiment of the invention.

FIG. 5 shows another illustrative display for displaying an evaluation of the business transformation according to an embodiment of the invention.

FIG. 6 shows an illustrative lifecycle of a business transformation according to an embodiment of the invention.

It is noted that the drawings are not to scale. The drawings are intended to depict only typical aspects of the invention, and therefore should not be considered as limiting the scope of the invention. In the drawings, like numbering represents like elements between the drawings.

### DETAILED DESCRIPTION OF THE INVENTION

As described in the related co-owned and co-pending U.S. patent application Ser. No. 11/200,847, filed on Aug. 10, 2005, and entitled “Business Solution Evaluation”, value modeling is used to quantify the business values and risks of one or more business capabilities (e.g., an information technology (IT) capability) by taking into account the relationships that the business capabilities have with business processes. The value modeling provides a comprehensive solution to vertically and horizontally modeling enterprise business value. For example, the value modeling solution enables: vertically linking business values with business activities, processes, capabilities, and their associated value drivers, financial measures, operational metrics, and the like; and horizontally considering multiple business activities, capabilities, value metrics (e.g., value drivers), and/or the like.

The invention described herein enhances the value modeling solution for evaluating business solutions. To this extent, as indicated above, the invention provides a solution for managing a business transformation. The invention obtains an impact of a business solution for the business transformation on a business concern for an enterprise and relationship information for the business concern with one or more other business concerns and/or value (business) metrics. The impact of the business solution is propagated to a set of business concerns and/or value metrics based on the relationship information. The impact can include a time delay factor, which can be used during evaluation to perform numerous financial related metrics (e.g., return on investment). The relationship information and/or impact can be derived from empirical data using regression analysis or the like. In order to facilitate evaluation of the business transformation, various improved graphical interfaces can be generated that highlight the changes caused by the business transformation for use by a user. The invention can be used during various phases of a lifecycle (e.g., a service management lifecycle) of the business transformation in order to provide improved predictions and/or indications of the value of the business transformation. As used herein, unless otherwise noted, the term “set” means one or more (i.e., at least one) and the phrase “any solution” means any now known or later developed solution.

To this extent, the invention provides a solution for managing a business transformation. As used herein, the phrase “business transformation” comprises the process by which any set of modifications are made to the operation of a business/enterprise. These modifications can include, for example: implementation of a new business solution; improvement/replacement of an existing business solution; outsourcing of a business solution; removal of a business solution; and/or the like. Further, as used herein, the phrase “business solution” includes one or more modifications to one or more business concerns/activities for the business. The invention provides a systematic solution for assessing an impact of a business transformation (e.g., a technology investment) in a diverse set of business process performance metrics and strategic value drivers. Additionally, the invention can be applied to the calculation of business value of generic business transformations including outsourcing services, IT solutions, and the like. Further, the invention provides a solution that can measure the business value of a business transformation that comprises a combination of multiple business solutions.

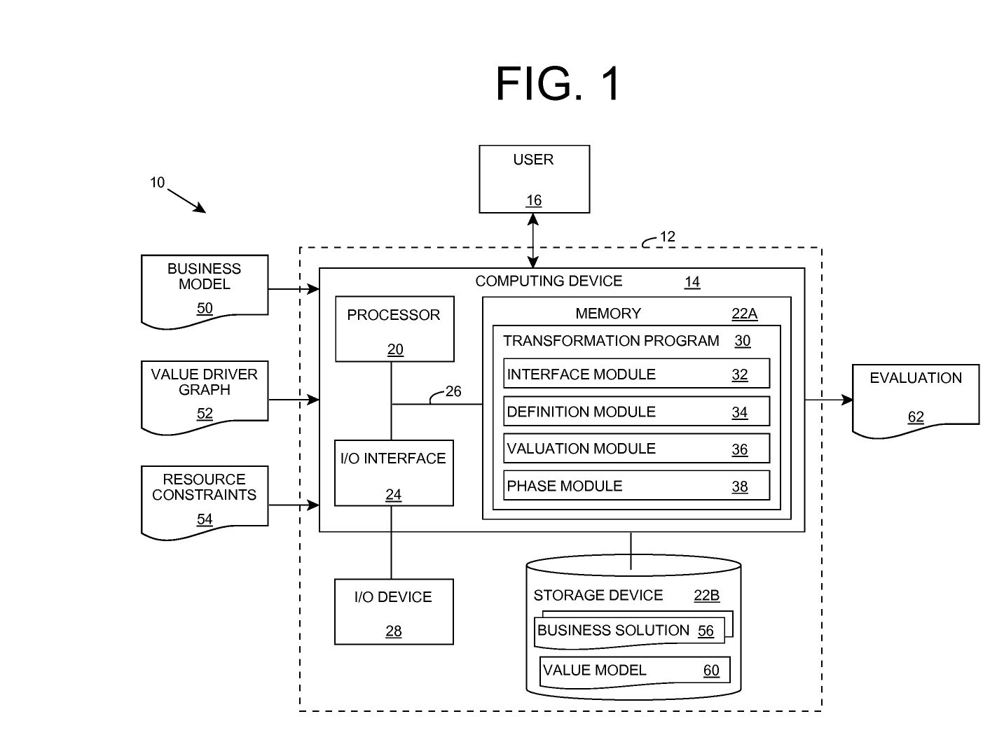

Turning to the drawings, FIG. 1 shows an illustrative environment 10 for managing a business transformation according to an embodiment of the invention. To this extent, environment 10 includes a computer system 12 that can perform the process described herein in order to manage the business transformation. In particular, computer system 12 is shown including a computing device 14 that comprises a transformation program 30, which makes computing device 14 operable to manage the business transformation by performing the process described herein.

Computing device 14 is shown including a processor 20, a memory 22A, an input/output (I/O) interface 24, and a bus 26. Further, computing device 14 is shown in communication with an external I/O device/resource 28 and a storage device 22B. In general, processor 20 executes program code, such as transformation program 30, which is stored in a storage system, such as memory 22A and/or storage device 22B. While executing program code, processor 20 can read and/or write data, such as business solution 56, to/from memory 22A, storage device 22B, and/or I/O interface 24. Bus 26 provides a communications link between each of the components in computing device 14. I/O device 28 can comprise any device that transfers information between a user 16 and computing device 14. To this extent, I/O device 28 can comprise a user I/O device to enable an individual user 16 to interact with computing device 14 and/or a communications device to enable a system user 16 to communicate with computing device 14 using any type of communications link.

In any event, computing device 14 can comprise any general purpose computing article of manufacture capable of executing program code installed thereon. However, it is understood that computing device 14 and transformation program 30 are only representative of various possible equivalent computing devices that may perform the process described herein. To this extent, in other embodiments, the functionality provided by computing device 14 and transformation program 30 can be implemented by a computing article of manufacture that includes any combination of general and/or specific purpose hardware and/or program code. In each embodiment, the program code and hardware can be created using standard programming and engineering techniques, respectively.

Similarly, computer system 12 is only illustrative of various types of computer systems for implementing the invention. For example, in one embodiment, computer system 12 comprises two or more computing devices that communicate over any type of communications link, such as a network, a shared memory, or the like, to perform the process described herein. Further, while performing the process described herein, one or more computing devices in computer system 12 can communicate with one or more other computing devices external to computer system 12 using any type of communications link. In either case, the communications link can comprise any combination of various types of wired and/or wireless links; comprise any combination of one or more types of networks; and/or utilize any combination of various types of transmission techniques and protocols.

As discussed herein, transformation program 30 enables computer system 12 to manage a business transformation. To this extent, transformation program 30 is shown including an interface module 32, a definition module 34, a valuation module 36, and a phase module 38. Operation of each of these modules is discussed further herein. However, it is understood that some of the various modules shown in FIG. 1 can be implemented independently, combined, and/or stored in memory of one or more separate computing devices that are included in computer system 12. Further, it is understood that some of the modules and/or functionality may not be implemented, or additional modules and/or functionality may be included as part of computer system 12.

Regardless, the invention provides a solution for managing a business transformation for an enterprise (business). In particular, transformation program 30 can evaluate one or more business solutions 56 for the business transformation. To this extent, interface module 32 can obtain a set of business solutions 56 for the business transformation. Each business solution 56 can be evaluated with respect to a particular enterprise. Consequently, interface module 32 can obtain a business model 50, a value driver graph 52, a set of resource constraints 54, and/or the like, in order to perform the evaluation for the enterprise.

In general, business model 50 comprises any type of representation of the operations performed by the enterprise. To this extent, business model 50 can include a set of business concerns for the target enterprise. A business concern comprises any type of element used to represent some aspect of the enterprise. For example, a business concern can comprise an element that represents a business process, a business activity, a business component, a resource, and/or the like. Further, a business concern can comprise an element that represents a relationship between two or more other business concerns. In one embodiment, business model 50 is developed using IBM's component business modeling (CBM) approach. However, it is understood that this is only illustrative, and any type of business model 50 can be used.

In one embodiment, a business concern is represented by a set of business processes and business activities. Further, each business process/activity can comprise an internal structure of various components. For example, a business process/activity can comprise a hierarchy of components that are used to implement the business process/activity. In this case, the business process/activity can be based on a business process model/workflow model, which is generated by one or more formal studies of businesses and enterprises.

In any event, value driver graph 52 generally represents relationships between various metrics. To this extent, value driver graph 52 can comprise a plurality of driver levels, each of which includes at least one driver metric node. A driver metric node represents a unique business measure, such as a cost, a revenue, a value, etc. Resource constraints 54 can comprise a set of limitations on an availability of a set of resources, such as an amount of time required, a number of man-hours, IT requirements, and/or the like for the enterprise. Additionally, each business solution 56 can comprise a set of resource requirements that define a set of resource requirements for implementing the business solution 56.

Interface module 32 can obtain the various data using any solution. For example, interface module 32 can generate a user interface for display to user 16, which enables user 16 to select some or all of the data. Further, interface module 32 can define an application program interface (API) or the like that enables user 16, another computer system in this case, to communicate and/or designate some or all of the data to interface module 32. Still further, interface module 32 can generate and/or be used to generate some or all of the data. Regardless, the data can be stored in any type of storage device using any solution (e.g., one or more files, records in a database, and/or the like). Additionally, interface module 32 can read a copy of some or all of the data into a dynamic memory, process the data in the dynamic memory, and write any modifications to the data to the storage device using any solution.

Definition module 34 can generate a value model 60 based on the data for the enterprise and the business solution 56. In one embodiment, definition module 34 can generate value model 60 as shown and described in the related co-owned and co-pending U.S. patent application Ser. No. 11/200,727, filed on Aug. 10, 2005, and entitled “Value Model”. To this extent, definition module 34 can generate value model 60 for a set of business solutions 56 (i.e., a business transformation) by obtaining relationship information between a business solution 56 and a set of business concerns in business model 50. Further, definition module 34 can obtain relationship information between a business concern in business model 50 and a set of business metrics in value driver graph 52. Definition module 34 can combine business solution(s) 56, business model 50, value driver graph 52, the relationship information between each business solution 56 and business concerns in business model 50, and the relationship information between business concerns in business model 50 and business metrics in value driver graph 52 to create value model 60. Additionally, value model 60 can include aggregate relationship information, which can be used to account for any dependencies (e.g., synergistic, cannibalistic, statistical) that may be present among different relationships.

Definition module 34 can obtain the relationship information using any solution. For example, definition module 34 can generate a user interface, such as a tree editor, that enables user 16 to graphically define (e.g., add, modify, delete) a relationship between a business solution 54 and a business concern in business model 50. Further, the user interface can enable user 16 to define various attributes of the relationship as described herein. Likewise, the same and/or similar user interfaces generated by definition module 34 can enable user 16 to define relationship information between the business concerns and business metrics in a similar manner. Additionally, definition module 34 can obtain some or all of the relationship information using an API or the like as described herein.

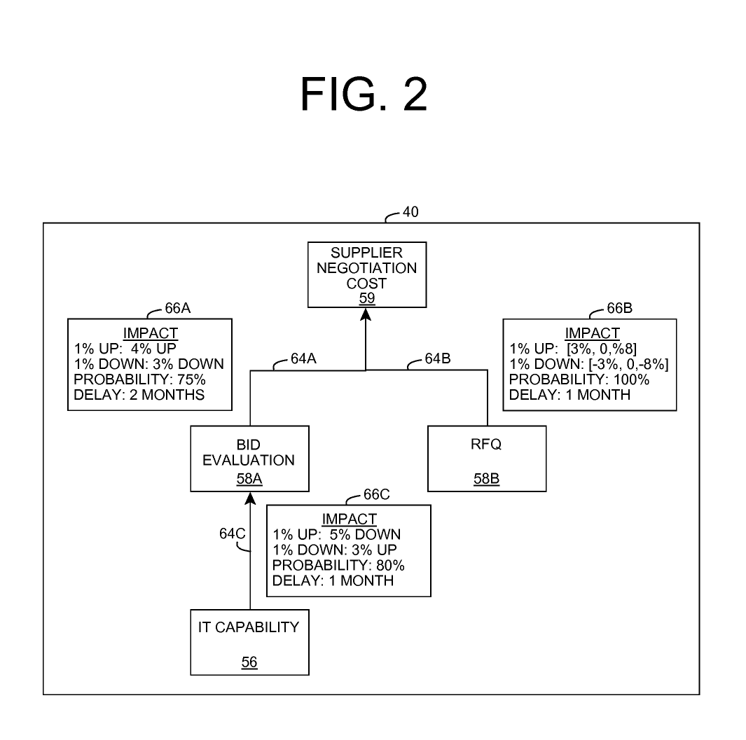

FIG. 2 shows an illustrative user interface 40 that can be generated by definition module 34 (FIG. 1) according to an embodiment of the invention. As shown, user interface 40 displays a business solution 56, business concerns 58A-B, and a business metric 59 as nodes in a graph and their corresponding relationship information 64A-C as directed links between the nodes. User interface 40 can comprise any combination of user interface controls that enable user 16 (FIG. 1) to define the relationship information 64A-C between business solution 56, business concerns 58A-B, and business metric 59.

The relationship information 64A-C between two nodes can define an impact that a change in one node will have on the other node. To this extent, the impact will include various attributes 66A-C. For example, the impact can define a quantitative relationship between the two nodes. Additionally, the relationship information 64A-C can comprise a time delay factor. The time delay factor represents a quantity of time before which the change in the related node will be reflected in the impacted node. For example, a change in IT capability 56 may not be reflected in bid evaluation 58A for a period of one month. Similarly, a change in bid evaluation 58A may take two months before it is reflected in supplier negotiation cost 59. The time delay factor can be expressed using any solution, e.g., a number of days, weeks, months, etc., as a number of periods (each of which is a fixed time period) for a simulation, and/or the like.

The quantitative relationship can comprise a sensitivity with which change in one node impacts the other node. Various types and/or combinations of sensitivity are possible, such as quantitative impact sensitivity, qualitative impact sensitivity, relative impact sensitivity, and/or the like. The sensitivity can be defined using any solution. For example, in one embodiment, the sensitivity is defined using a 1% sensitivity analysis, which defines a percent change in the impacted node when the related node changes 1%. For example, a 1% sensitivity metric for revenue can comprise a percent change if a metric, such as order process time, is reduced/increased 1%. The 1% sensitivity value can comprise a single value for an increase/decrease, or two values, one for an increase and one for a decrease (if the relationship is not symmetric). Additionally, the quantitative relationship can include a probability (e.g., confidence) that the sensitivity relationship will be accurate. The probability can be expressed as a percentage (as shown in attributes 66A, 66C), as a most likely, min, max tuple of values (as shown in attribute 66B), and/or the like.

Definition module 34 (FIG. 1) and/or user 16 (FIG. 1) can derive/obtain the quantitative relationship from any source. For example, the quantitative relationship can be obtained from a model of a particular business domain of the enterprise (e.g., oil company). Further, the quantitative relationship can be derived from actual data based on previous analyses for similar enterprises, node combinations, and/or the current enterprise. To this extent, data on a current enterprise can be used to customize the quantitative relationship obtained from a generic model of the enterprise domain.

Frequently, a quantitative relationship between two or more nodes is not readily available. To this extent, in one embodiment, definition module 34 (FIG. 1) calculates the quantitative relationship based on empirical (e.g., historical) data. Definition module 34 can obtain the empirical data using any solution. Further, the empirical data can be generated based on the enterprise, other similar enterprises (e.g., size, domain), and/or the like. In any event, definition module 34 can use any combination of various types of mathematical/statistical analyses to calculate the quantitative relationship. For example, definition module 34 can use the 1% sensitivity analysis described herein.

Further, when empirical data is available in a suitable format, definition module 34 (FIG. 1) can use a set of regression algorithms to compute and enhance deltas estimation based on the empirical data. In this case, definition module 34 can obtain a correlation period for use in calculating a correlation using a regression algorithm using any solution. The correlation period is a number of periods backwards from a latest value of an element from which the correlation arrow starts. For example, to calculate the correlation between customer retention and turnover, the period of time backwards from the present time point from which the data taken is first decided. Subsequently, definition module 34 can automatically calculate a maximum correlation between two business elements (e.g., nodes) in value model 60 (FIG. 1). To this extent, the regression analysis also can be used to prove/disprove assumptions about correlations among two or more business elements.

Definition module 34 (FIG. 1) can use any combination of various regression algorithms (e.g., linear, nonlinear). Additionally, definition module 34 can use a time delay factor in the regression analysis. In this case, a value of a particular node at a time t may be calculated using values of another node at a time t−1. It is understood that any combination of nodes may contribute to the value of a single node. To this extent, the values of each node can be taken at any of various times (e.g., t, t−1, t−2, etc.). The time used for each value will depend on the particular relationship and time delay factor between the respective nodes.

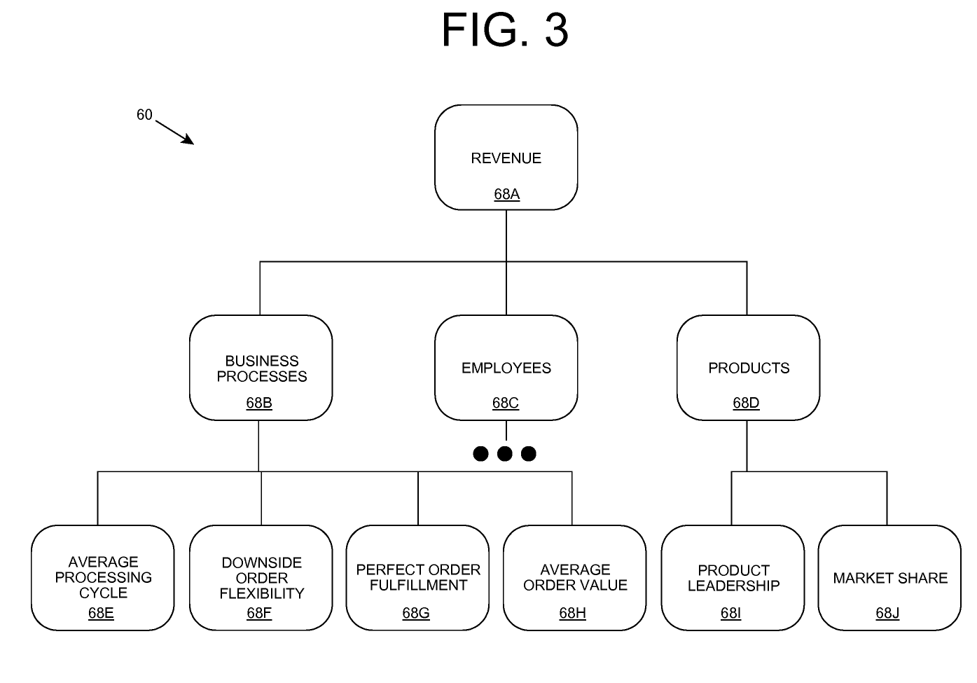

Using empirical data and regression analysis, definition module 34 (FIG. 1) can make various determinations. For example, FIG. 3 shows an illustrative value model 60 according to an embodiment of the invention. As illustrated, revenue (R) 68A is impacted by business processes 68B, employees 68C, and products 68D. Further, business process metrics include average processing cycle (APC) 68E, downside order flexibility 68F, perfect order fulfillment (POF) 68G, average order value (AOV) 68H, and the like. Product metrics include product leadership 68I and market share 68J. While not shown, it is understood that various employee metrics and/or additional business process and/or product metrics can also be included.

In any event, definition module 34 (FIG. 1) can use a regression algorithm and empirical data to determine which factors (e.g., nodes 68B-J) are important to revenue 68A, which factors are the primary factors, what is the relationship of the primary factors to revenue 68A, whether there is a time delay factor, and the like. To this extent, definition module 34 can use regression analysis to generate a relationship (e.g., a linear relationship) among the business elements 68A-J. After analysis, it may be determined that revenue 68A is highly dependent on business processes 68B while employees 68C and products 68D are not highly relevant. Further, it may be determined that downside order flexibility 68F is not an important process metric with respect to revenue 68A. Still further, it may be determined that perfect order fulfillment 68G has a time lag of one time period (e.g., one month) before a change is propagated to revenue. In this case, revenue at time t can be represented by a formula:

R(t)=a₀+a₁APC(t)+a₂POF(t−1)+a₃AOV(t),

where a₀₋₃ are the regression coefficients determined using the regression algorithm.

Returning to FIG. 1, once definition module 34 has generated value model 60, valuation module 36 can use value model 60 to evaluate a set of business solutions 56 for a business transformation. To this extent, valuation module 36 can use value model 60 to propagate an impact that a business solution 56 has on business concern(s) 58A-B (FIG. 2) to other business concern(s) 58A-B, value metric(s) 59 (FIG. 2), and/or the like, which are related to the impacted business concern. Valuation module 36 can generate an evaluation 62 of the business solution 56 and/or business transformation based on the propagated impact(s).

Valuation module 36 can evaluate business solution(s) 56 based on the absolute benefit provided as defined by the impact(s) and value model 60. However, each business solution 56 will generally require some set of resources (e.g., money, personnel, time, and/or the like) to implement. To this extent, each business solution 56 can include a set of resource requirements. Valuation module 36 can use the set of resource requirements when evaluating the set of business solutions 56. To this extent, valuation module 36 also can obtain a set of resource constraints 54, which defines an amount of the various types of resources that are available for the business transformation. In this case, the set of business solutions 56 for the business transformation can be selected such that the total resource requirements for the business transformation remain within the resource constraints 54.

In any event, returning to FIG. 2, valuation module 36 (FIG. 1) can perform both sequential propagation (e.g., node 56 to node 58A to node 59) and parallel propagation (e.g., nodes 58A-B to node 59). In sequential propagation, the impacts are multiplied. To this extent, a 1% increase in IT capability 56 will result in a 5% decrease in bid evaluation 58A, which in turn will result in a 15% decrease in supplier negotiation cost 59 (5×1% sensitivity of 3%). In parallel propagation, the impacts are added. Consequently, assuming a 2% increase for RFQ 58B is also expected (e.g., due to another business solution in the business transformation), which results in an expected 6% increase in supplier negotiation cost 59, the total impact of nodes 58A-B on supplier negotiation cost 59 would be a 9% decrease (−15%+6%).

As discussed herein, each impact can be expressed using any of various formats, e.g., 1% sensitivity with probability, most likely/min/max tuple, distribution (e.g., normal distribution), mean/range, and/or the like. To this extent, when propagating the impact, valuation module 36 (FIG. 1) also can propagate any error estimations. For example, a probability can be propagated sequentially or in parallel by multiplying the probabilities. A range can be similarly propagated using any solution. For example, in parallel propagation, valuation module 36 can add minimums and maximums, while for sequential propagation, valuation module 36 can find a minimum and a maximum of the products of the minimums and maximums.

Additionally, valuation module 36 (FIG. 1) can propagate time delay factors. To this extent, when sequentially propagating time delay factors, valuation module 36 can add the values (e.g., 1 month for attributes 66C plus 2 months for attributes 66A=3 months before impact on supplier negotiation cost 59). When propagating parallel time delay factors, valuation module 36 can maintain a list of the unique time delays for supplier negotiation cost 59, which can be used to sequentially apply and propagate the corresponding impacts for each node 58A-B. In this manner, the time delay factor and corresponding impacts can be used to assist in various financial measures, such as return on investment, net present value, payback period, internal rate of return, and the like. Alternatively, valuation module 36 can use a maximum of the propagated time delay factors (e.g., max[propagated time delay for relationship 64A=3 months, time delay for relationship 64B=1 month]=3 months before combined impact on supplier negotiation cost 59).

Further, attributes 66A-C can include a type for the time delay factor. In general, the time delay factor can comprise one of two types, a gradational (continuous) time delay and a discrete (step) time delay. For a gradational time delay, the impact gradually rises from zero to the maximum impact over a period of time defined by the time delay. After the period of time, the impact remains constant at the maximum. For example, an increase in market share may result in a gradual increase in revenue over a time period. For a discrete time delay, no impact is seen until after the time delay, at which point the maximum impact is obtained and remains constant thereafter. For example, an improvement to a process efficiency may only be propagated when a corresponding project is completed some time period later.

In either case, the type for the time delay factor can be used to determine cash flow over a number of periods. For example, a business solution may require an initial investment to implement that is expended in period zero. For a gradational time delay, the benefit (translated to a financial measure) can be gradually increased over the time delay, while for a discrete time delay, the benefit can be delayed until the end of the time delay. Using these measures, financial analyses, such as return on investment, net present value, and the like, can be calculated using any solution. Further, when a node includes multiple time delay factors (e.g., due to parallel propagation), the appropriate time delays and types can be combined to determine the interim returns up until the maximum time delay.

Returning to FIG. 1, evaluation 62 can comprise a report that is embodied in any tangible medium of expression (e.g., as electronic data, a paper copy, and/or the like) and enables user(s) 16 to evaluate the propagated impact. Further, evaluation 62 can comprise any combination of analyses for the set of business solutions 56 in the business transformation that enable the business transformation to be evaluated in a desired manner. In one embodiment, valuation module 36 generates an evaluation 62 that comprises one or more user interfaces for presenting the evaluation to user 16 in an electronic manner. Further, the user interfaces can enable user 16 to adjust one or more attributes of the set of business solutions 56 and/or the value model 60 and dynamically evaluate the effect(s) of the adjustment(s).

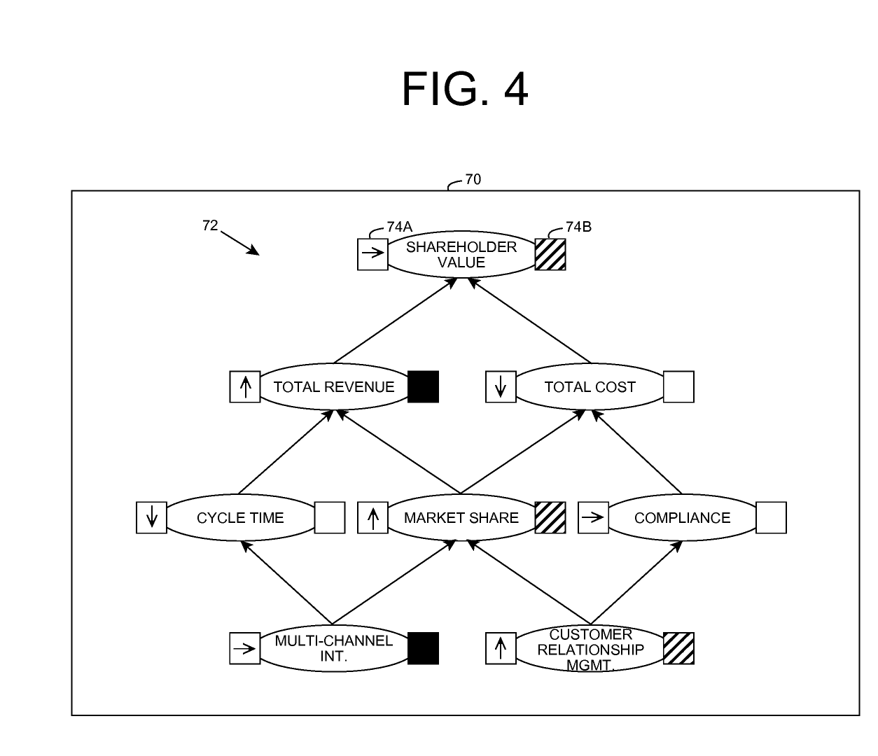

FIG. 4 shows an illustrative display 70, which valuation module 36 (FIG. 1) can generate, for displaying the evaluation of the business transformation according to an embodiment of the invention. Display 70 includes a hierarchical graph 72 that includes a plurality of nodes, each of which corresponds to a unique business solution, business concern, value metric, and/or the like, and a set of links, each of which displays a relationship between a pair of nodes. In one embodiment, hierarchical graph 72 includes a single top-level node (e.g., shareholder value), which comprises a “focus” metric for the graph 72 and is decomposed into various metrics that impact the value of the focus metric. To this extent, hierarchical graph 72 can include one or more levels of value metrics and one or more levels of business concerns, and have a bottom-most level that comprises one or more business solutions 56 (FIG. 1) being evaluated. In this manner, hierarchical graph 72 graphically renders a value creation network, which enables a user 16 (FIG. 1) to readily view the impact(s) that the business transformation will have on various value metrics.

To this extent, each node can comprise a set of value attributes. In one embodiment, the value attributes include a current value, a target value, and an alarm value. Based on these values, a pair of indicators, such as indicators 74A-B, can be updated for each node. For example, indicator 74A comprises a trend indicator, which provides a visual representation of whether the current value for the metric is improving (up arrow), deteriorating (down arrow) or is remaining substantially unchanged (side arrow). Further, indicator 74B comprises a status indicator, which provides a visual representation of an indication of the current value with respect to a target and/or alarm value. For example, a current value that is at or above the target value can have a white status indicator 74B, a current value that is between the target value and an alarm value can have a striped status indicator 74B, and a current value that is at or below an alarm value can have a black status indicator 74B. It is understood that the particular configuration and properties of status indicators 74A-B are only illustrative and numerous variations are possible under the invention.

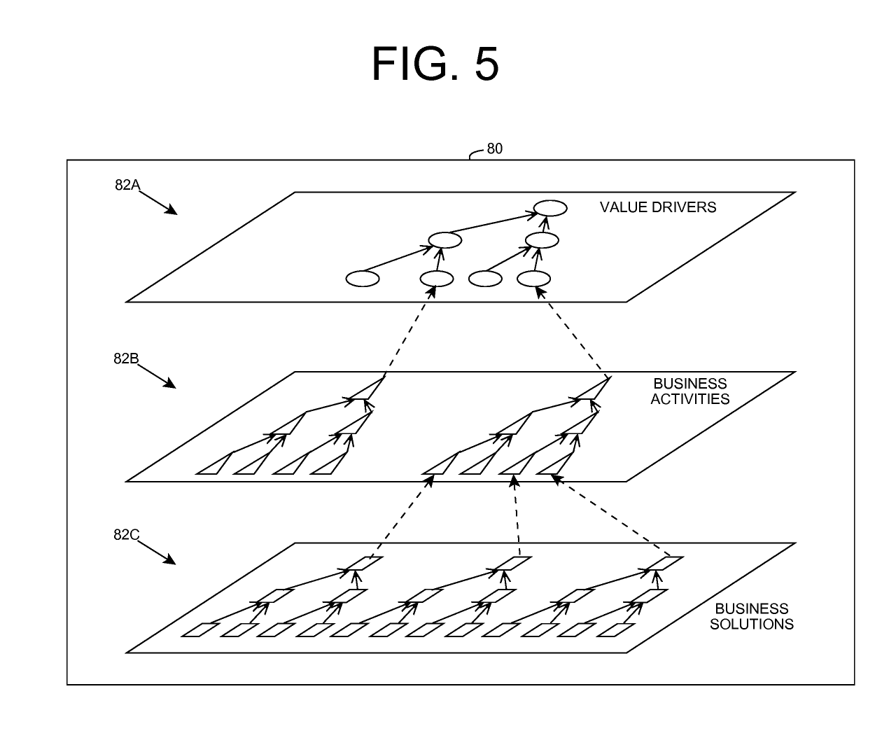

FIG. 5 shows another illustrative display 80, which valuation module 36 (FIG. 1) can generate, for displaying the evaluation of the business transformation according to an embodiment of the invention. Display 80 includes a plurality of panes 82A-C, each of which can correspond to business solution information (e.g., pane 82C), business concern information (e.g., pane 82B) and value metric information (e.g., pane 82A). It is understood that while three panes 82A-C are shown, display 80 can include more or fewer panes 82A-C. For example, display 80 could be generated with only panes 82A-B or only panes 82B-C. In any event, display 80 further includes linking information that displays relationship information between any two panes 82A-C. In particular, the relationship information can comprise one or more relationships from a business solution in pane 82C to a business concern in pane 82B and one or more relationships between a business concern in pane 82B to a value metric in pane 82C.

As shown, one or more business solutions, business concerns, and/or value metrics can be represented using a separate graph that illustrates one or more components of the solution, concern, and/or metric. To this extent, pane 82C is shown illustrating three business solutions, pane 82B is shown illustrating two business concerns, and pane 82A is shown illustrating one value metric. While each solution, concern, and metric is shown represented by a graph having three levels, it is understood that these are only representative and any number of levels (including one) and nodes can be used.

In any event, pane 82A displays a value driver of an enterprise and its corresponding structure. Pane 82B displays the structure of the various business concerns that are executed in order to achieve a business value, which is related to a value metric in pane 82A. Pane 82C displays the structure and classification of business solutions deployed, to be deployed, proposed, and/or the like, to assist in the execution of one or more related business concerns in pane 82B. For each node in the structures, panes 82A-C can display a pair of values, e.g., a current value and an expected value should the business transformation be performed.

Because different roles are included in value modeling, and different roles focus on different aspects of it, the use of multi-panes for representing various elements of business models in a structured way is useful for value modeling as a communication mechanism to help users 16 (FIG. 1) visualize and identify relevant value drivers, business concerns, and solutions. The graph structures represent the elements of an enterprise in terms of hypothesized cause-and-effect relationships among value drivers, business concerns and solutions. The graphs show one or more hierarchical structures and serve to avoid ambiguous effects. According to a psychological learning theory, the human cognitive paradigm is hierarchical and progressive. Using the hierarchical structure to model business elements and describe business strategies provides a number of benefits such as a solution for deduction and inference, a good fit with human thinking paradigm, an effective solution for building and managing business elements, enablement of dynamic change implementation, and/or the like.

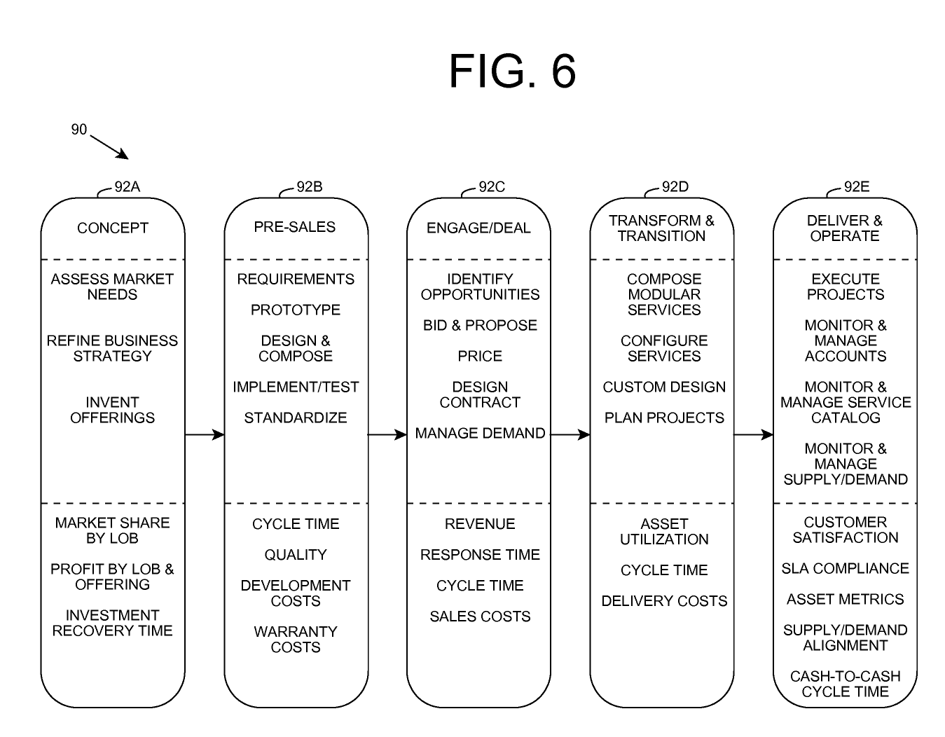

Returning to FIG. 1, value model 60 can be used to support various phases of a business transformation. To this extent, phase module 38 can manage a lifecycle for the business transformation (e.g., one or more of the business solutions 56). In general, the lifecycle includes a plurality of phases. At each phase, the business transformation is analyzed to determine progress, make one or more decisions, and/or the like. FIG. 6 shows an illustrative lifecycle 90 of a business transformation, which phase module 38 (FIG. 1) can manage, according to an embodiment of the invention. In this case, lifecycle 90 includes five phases 92A-E (e.g., concept, pre-sales, engage/deal, transform & transition, deliver & operate). In general, each phase 92A-E is performed in succession. However, it is understood that phases 92A-E are only illustrative and any combination of phases 92A-E could be incorporated. For example, an alternative lifecycle 90 can comprise four phases (e.g., value identification, value solutioning, value deal making, value delivery). Further, it is understood that two or more phases 92A-E may overlap, output from one phase 92A-E may be used as feedback for re-performing a previous phase, and/or the like.

In any event, each phase 92A-E includes a corresponding set of core processes, shown in the center of each phase 92A-E, and a corresponding set of metrics, shown in the bottom of each phase 92A-E. Value model 60 (FIG. 1) and the various analysis tools (e.g., displays 70, 80 of FIGS. 4 and 5, respectively) can support the implementation of one or more of the core processes and/or analysis of one or more of the core metrics for each phase 92A-E. For example, in concept phase 92A, valuation module 36 (FIG. 1) can estimate profit by line of business (LOB) and offering and investment recovery time. In pre-sales phase 92B, valuation module 36 can estimate benefits of various service options, provide a better understanding of involved risks, shorten a sales cycle (by clearly showing the resulting value), and improve a win rate for a service provider. Additionally, in engage/deal phase 92C, valuation module 36 can estimate a value of a proposal, provide insight into financial risks, facilitate proposal and service level agreement (SLA) composition and pricing with confidence, and the like.

During implementation of the business transform in transform and transition phase 92D, valuation module 36 (FIG. 1) can estimate cost and benefits of various service configuration options, provide a better understanding of involved risks, and the like. In deliver and operate phase 92E, valuation module 36 can confirm SLA compliance by tracking benefits actually delivered by implemented services, analyze impacts on customer satisfaction, facilitate portfolio management of offerings, help renegotiation of service contracts, and/or the like.

Returning to FIG. 1, phase module 38 can manage data generated at each phase (e.g., generate empirical data), which can be used for subsequent comparison, revision, and/or the like. To this extent, phase module 38 can adjust one or more aspects of value model 60 and/or the data on which value model 60 is based (e.g., business model 50, value driver graph 52) in response to measured results after one or more of the phases 92A-E (FIG. 6) in the lifecycle. In this manner, transformation program 30 provides functionality that quantifies and formulates financial benefits (e.g., revenue and cost) of a business transformation, thereby enabling an improved understanding of cost, performance, risks, and/or the like during each phase 92A-E of the lifecycle.

Further, transformation program 30 and the process described herein can assist with numerous additional business practices. For example, the invention can provide an accurate value evaluation, which facilitates the visibility of intangible benefit as well as tangible payoff such as cost reduction. Additionally, the invention can be used to generate business cases that take into account intangible value. Further, the invention can facilitate project portfolio management with a value-centric investment selection and optimization process. Still further, the invention is also useful for monitoring and tracking project performance against a target business value of initiatives and projects.

While shown and described herein as a method and system for managing a business transformation, it is understood that the invention further provides various alternative embodiments. For example, in one embodiment, the invention provides a computer program stored on a computer-readable medium, which when executed, enables a computer system to implement a method of managing a business transformation. To this extent, the computer-readable medium includes program code, such as transformation program 30 (FIG. 1), which implements the process described herein. It is understood that the term “computer-readable medium” comprises one or more of any type of tangible medium of expression (e.g., physical embodiment) of the program code. In particular, the computer-readable medium can comprise program code embodied on one or more portable storage articles of manufacture, on one or more data storage portions of a computing device, such as memory 22A (FIG. 1) and/or storage system 22B (FIG. 1), as a data signal traveling over a network (e.g., during a wired/wireless electronic distribution of the computer program), on paper (e.g., capable of being scanned and converted to electronic data), and/or the like.

In another embodiment, the invention provides a method of generating a system for managing a business transformation. In this case, a computer system, such as computer system 12 (FIG. 1), can be obtained (e.g., created, maintained, having made available to, etc.) and one or more programs/systems for performing the process described herein can be obtained (e.g., created, purchased, used, modified, etc.) and deployed to the computer system. To this extent, the deployment can comprise one or more of: (1) installing program code on a computing device, such as computing device 14 (FIG. 1), from a computer-readable medium; (2) adding one or more computing devices to the computer system; and (3) incorporating and/or modifying one or more existing devices of the computer system, to enable the computer system to perform the process described herein.

In still another embodiment, the invention provides a business method that performs the process described herein on a subscription, advertising, and/or fee basis. That is, a service provider could offer to manage a business transformation as described herein. In this case, the service provider can manage (e.g., create, maintain, support, etc.) a computer system, such as computer system 12 (FIG. 1), that performs the process described herein for one or more customers. In return, the service provider can receive payment from the customer(s) under a subscription and/or fee agreement, receive payment from the sale of advertising to one or more third parties, and/or the like.

As used herein, it is understood that “program code” means any expression, in any language, code or notation, of a set of instructions that cause a computing device having an information processing capability to perform a particular function either directly or after any combination of the following: (a) conversion to another language, code or notation; (b) reproduction in a different material form; and/or (c) decompression. To this extent, program code can be embodied as some or all of one or more types of computer programs, such as an application/software program, component software/a library of functions, an operating system, a basic I/O system/driver for a particular computing, storage and/or I/O device, and the like.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to an individual in the art are included within the scope of the invention as defined by the accompanying claims.

What is claimed is:

1. A method of managing a business transformation, the method comprising:
obtaining an impact of a business solution for the business transformation on a business concern, the impact including a time delay factor;
obtaining relationship information for the business concern and at least one of: a set of value metrics or a set of other business concerns;
propagating the impact to at least one of: another business concern or a value metric based on the relationship information;
evaluating the business transformation based on the propagated impact; and
storing an evaluation based on the evaluating.

2. The method of claim 1, further comprising obtaining a set of resource requirements for the business solution, the evaluating being further based on the set of resource requirements.

3. The method of claim 1, the evaluating including generating a display for viewing the propagated impact.

4. The method of claim 3, the display including:
a first pane for displaying business solution information;
a second pane for displaying business concern information; and
linking information that displays the relationship information between the business solution information and the business concern information.

5. The method of claim 4, the display further including:
a third pane for displaying value metric information; and
linking information that displays relationship information between the business concern information and the value metric information.

6. The method of claim 3, the display including a hierarchical graph, the hierarchical graph including:
a set of nodes, each node comprising a unique node for at least one of: a business solution, a business concern, and a value metric, and each node including a status indicator and a trend indicator; and
a set of links, each link displaying a relationship between a pair of nodes.

7. The method of claim 1, the obtaining an impact including calculating the impact based on the time delay factor, a quantitative relationship between the business solution and the business concern, and a probability for the quantitative relationship.

8. The method of claim 7, the obtaining an impact further including:
obtaining a set of empirical data; and
calculating the quantitative relationship using the set of empirical data and regression analysis.

9. The method of claim 1, further comprising managing a lifecycle for the business solution, wherein the evaluating occurs during at least one phase of the lifecycle.

10. A system for managing a business transformation, the system including at least one computing device comprising:
a system for obtaining an impact of a business solution for the business transformation on a business concern, the impact including a time delay factor;
a system for obtaining relationship information for the business concern and at least one of: a set of value metrics or a set of other business concerns;
a system for propagating the impact to at least one of: another business concern or a value metric based on the relationship information; and
a system for evaluating the business transformation based on the propagated impact.

11. The system of claim 10, the system for evaluating including a system for generating a display for viewing the propagated impact.

12. The system of claim 11, the display including:
a first pane for displaying business solution information;
a second pane for displaying business concern information; and
linking information that displays the relationship information between the business solution information and the business concern information.

13. The system of claim 11, the display including a hierarchical graph, the hierarchical graph including:
a set of nodes, each node comprising a unique node for at least one of: a business solution, a business concern, and a value metric, and each node including a status indicator and a trend indicator; and
a set of links, each link displaying a relationship between a pair of nodes.

14. The system of claim 10, the system for obtaining an impact including:
a system for calculating the impact based on the time delay factor, a quantitative relationship between the business solution and the business concern, and a probability for the quantitative relationship;
a system for obtaining a set of empirical data; and
a system for calculating the quantitative relationship using the set of empirical data and regression analysis.

15. A computer program comprising program code stored on a physical computer-readable medium, which when executed, enables a computer system to implement a process of managing a business transformation, the method comprising:
obtaining an impact of a business solution for the business transformation on a business concern, the impact including a time delay factor;
obtaining relationship information for the business concern and at least one of: a set of value metrics or a set of other business concerns;
propagating the impact to at least one of: another business concern or a value metric based on the relationship information; and
evaluating the business transformation based on the propagated impact.

16. The computer program of claim 15, the evaluating including generating a display for viewing the propagated impact.

17. The computer program of claim 16, the display including:
a first pane for displaying business solution information;
a second pane for displaying business concern information; and
linking information that displays the relationship information between the business solution information and the business concern information.

18. The computer program of claim 16, the display including a hierarchical graph, the hierarchical graph including:
a set of nodes, each node comprising a unique node for at least one of: a business solution, a business concern, and a value metric, and each node including a status indicator and a trend indicator; and
a set of links, each link displaying a relationship between a pair of nodes.

19. The computer program of claim 15, the obtaining an impact including:
calculating the impact based on the time delay factor, a quantitative relationship between the business solution and the business concern, and a probability for the quantitative relationship;
obtaining a set of empirical data; and
calculating the quantitative relationship using the set of empirical data and regression analysis.

20. A method of generating a system for managing a business transformation, the method comprising:
providing a computer system operable to:
obtain an impact of a business solution for the business transformation on a business concern, the impact including a time delay factor;
obtain relationship information for the business concern and at least one of: a set of value metrics or a set of other business concerns;
propagate the impact to at least one of: another business concern or a value metric based on the relationship information; and
evaluate the business transformation based on the propagated impact.
